(19) United States
(12) Patent Application Publication
(10) Pub. No.: US 2016/0053204 A1
(43) Pub. Date: Feb. 25, 2016

(54) Caustic Aqueous Alkyl Polyglycoside Stripping Composition

(71) Applicant: Geo-Tech Polymers, LLC, Westerville, OH (US)

(72) Inventors: Douglas R. Gels, Lewis Center, OH (US); Kenneth J. Heater, Delaware, OH (US); Anne B. McCoppin, Powell, OH (US)

(21) Appl. No.: 14/830,639

(22) Filed: Aug. 19, 2015

Related U.S. Application Data
(60) Provisional application No. 62/039,203, filed on Aug. 19, 2014.
(60) Provisional application No. 62/119,161, filed on Feb. 21, 2015.

(51) Int. Cl. C11D 3/39; B08B 3/10; C11D 3/04

(52) U.S. Cl. CPC C11D 3/3942; C11D 3/044; B08B 3/10

(57) ABSTRACT

Compositions, process mixtures, and kits are provided for removing one or more coatings from a polymeric film, e.g., a food packaging film, using a single-phase aqueous solution. The single-phase aqueous solution may include water; an inorganic base composition; one or more of a stable peroxygen composition and a monosaccharide salt; and a surfactant composition.

### CROSS-REFERENCE TO RELATED APPLICATIONS

This application claims priority to U.S. Provisional Patent Application No. 62/039,203, filed on Aug. 19, 2014, and U.S. Provisional Patent Application No. 62/119,161, filed on Feb. 21, 2015, each of which are entirely incorporated herein by reference.

### BACKGROUND

Polymeric substrates, such as plastic regrind or shredded film formed in recycling processes, may include undesirable coatings. For example, coatings may include inks, labels, adhesives, metallic films, and the like, e.g., for food packaging, CD/DVDs, and the like. It is desirable to process such polymeric substrates to remove undesired coatings prior to further uses of the substrates, such as recycled feedstocks for plastic article manufacture. Existing processes use extremely caustic solutions, high temperatures and/or pressures, or costly reagents to remove coatings.

The present application appreciates that removing coatings from polymeric substrates may be a challenging endeavor.

### SUMMARY

In one embodiment, a single-phase aqueous solution is provided. The single-phase aqueous solution may be used for removing one or more coatings from a polymeric substrate. The single-phase aqueous solution may include water. The single-phase aqueous solution may include an inorganic base composition. The single-phase aqueous solution may include one or more of: a stable peroxygen composition and a monosaccharide salt. The single-phase aqueous solution may include a surfactant composition.

In another embodiment, a process mixture is provided. The process mixture may include a polymeric substrate. The polymeric substrate may include one or more coatings. The process mixture may include a single-phase aqueous solution. The single-phase aqueous solution may include water. The single-phase aqueous solution may include an inorganic base composition. The single-phase aqueous solution may include one or more of: a stable peroxygen composition and a monosaccharide salt. The single-phase aqueous solution may include a surfactant composition.

In one embodiment, a kit is provided. The kit may be for making a single-phase aqueous solution effective to remove one or more coatings from a polymeric substrate. The kit may include one or more of: an inorganic base composition, a stable peroxygen composition, a monosaccharide salt, and a surfactant composition. The kit may include instructions. The instructions may direct a user to combine one or more of: the inorganic base composition, the stable peroxygen composition, the monosaccharide salt, and the surfactant composition with water to form the single-phase aqueous solution.

In various embodiments, a method is provided for removing one or more coatings from a polymeric substrate using a single-phase aqueous solution. The method may include providing a single-phase aqueous solution. The single-phase aqueous solution may include water and one or more of: an inorganic base composition; a stable peroxygen composition; a monosaccharide salt, and a surfactant composition. The method may include providing a polymeric substrate. The polymeric substrate may include one or more coatings. The method may include contacting the single-phase aqueous solution and the polymeric substrate to form a process mixture under conditions effective to remove a portion of the one or more coatings from the polymeric substrate.

### BRIEF DESCRIPTION OF THE DRAWINGS

The accompanying figures, which are incorporated in and constitute a part of the specification, illustrate example methods and apparatuses, and are used merely to illustrate example embodiments.

FIG. 1 is a flow diagram describing an example method.

FIG. 2 is a block diagram of an example kit.

FIGS. 3A and 3B depict a table of compositions, reaction parameters, and results corresponding to EXAMPLES 1-5.

FIGS. 4A and 4B depict a table of compositions, reaction parameters, and results corresponding to EXAMPLE 6.

FIG. 5 is a table of compositions, reaction parameters, and results corresponding to EXAMPLE 7.

FIG. 6 is a table of compositions, reaction parameters, and results corresponding to EXAMPLE 8.

### DETAILED DESCRIPTION

The present application relates to compositions, process mixtures, kits, and methods for removing one or more coatings from a polymeric substrate, e.g., food packaging films; metalized coatings from, e.g., CDs and DVDs; plastic containers; films for personal care items, such as diapers; and the like.

In various embodiments, a single-phase aqueous solution is provided. The single-phase aqueous solution may be used for removing one or more coatings from a polymeric substrate. The single-phase aqueous solution may include the water in a weight percent (w/w) of the single-phase aqueous solution of at least about one or more of: 90%, 91%, 92%, 93%, 94%, 95%, 96%, 97%, 98%, 99%, 99.1%, 99.2%, 99.25%, 99.3%, or 99.35%, for example, at least about 95% by weight of water. The single-phase aqueous solution may include an inorganic base composition. The single-phase aqueous solution may include one or more of: a stable peroxygen composition and a monosaccharide salt. The single-phase aqueous solution may include a surfactant composition.

Various embodiments herein may recite the term “including,” or, in the claims, the term “comprising,” and their grammatical variants. For each such embodiment, corresponding additional embodiments are explicitly contemplated where the term “comprising” is replaced with “consisting essentially of” and “consisting of.” For example, the single-phase aqueous solution may consist essentially of: the water; the inorganic base composition; the stable peroxygen composition and/or the monosaccharide salt; and the surfactant composition. Further, for example, the single-phase aqueous solution may consist of: the water; the inorganic base composition; the stable peroxygen composition and/or the monosaccharide salt; and the surfactant composition.

In some embodiments, the one or more coatings may include, for example, one or more of: a paint, an ink, a dye, a powder coat, a paper label, a plastic label, an adhesive, a barrier coating, a metalized coating, food, or a bio-coating. The bio-coating may be, for example, protein-based, oligosaccharide-based, and the like. The metalized coating may include a continuous film or metal particulates.

In several embodiments, the polymeric substrate may be in pieces or particulates, for example, cut, shredded, or ground, e.g., as part of a recycling process. The polymeric substrate, may be in pieces or particles and may be one or more of: recycled; virgin plastic; flexible; fibrous; mixtures thereof; and the like. The polymeric substrate may include one or more of: polyethylene (PE), low-density polyethylene (LDPE), high-density polyethylene (HDPE), polypropylene (PP), biaxially oriented polypropylene (BOPP), polycarbonate (PC), polyethyelene terephthalate (PET), polyethyelene terephthalate-glycerol modified (PET-G), polylactic acid (PLA), polystyrene (PS), copolymers and block copolymers thereof, and the like. The polymeric substrate may include a food packaging film. The polymeric substrate may include a metalized polymer, such as polycarbonate from CD or DVD waste. The polymeric substrate may include a single layered or multilayered film. The polymeric substrate may include a plastic film or container material.

In various embodiments, the inorganic base composition may include one or more of: an alkali metal hydroxide, an alkaline earth metal oxide, or an alkaline earth metal hydroxide. Further, the inorganic base composition may consist of, or may consist essentially of, one or more of: the alkali metal hydroxide, the alkaline earth metal oxide, or the alkaline earth metal hydroxide. As used herein, alkali metals may include, for example, lithium, sodium, potassium, rubidium, or cesium. Alkaline earth metals may include, for example, beryllium, magnesium, calcium, strontium, or barium. For example, the inorganic base composition may include one or more of: lithium hydroxide, sodium hydroxide, potassium hydroxide, magnesium oxide, calcium oxide, magnesium hydroxide, or calcium hydroxide. The inorganic base composition may consist of, or may consist essentially of, one or more of: lithium hydroxide, sodium hydroxide, potassium hydroxide, magnesium oxide, calcium oxide, magnesium hydroxide, and calcium hydroxide. The inorganic base composition may include sodium hydroxide. The inorganic base composition may consist of, or may consist essentially of, sodium hydroxide.

In some embodiments, the inorganic base composition may be present in an amount effective to establish a desired hydroxide concentration in the single-phase aqueous solution. For example, the desired hydroxide concentration may have a molarity in moles/L (M) of: from about 0.0125 to about 0.625, from about 0.025 to about 0.5, from about 0.025 to about 0.375, from about 0.025 to about 0.25, from about 0.025 to about 0.125, about 0.125, about 0.0625, or a value or range of values based on any of the preceding, for example, from about 0.0125 to about 0.625, from about 0.025 to about 0.25, or about 0.125. For example, for sodium hydroxide, a molarity from about 0.025 to about 0.25 may correspond to a in a weight percentage (w/w) with respect to the water of from about 0.05% to about 2.5%, e.g., about 0.5% or about 0.375% sodium hydroxide.

In several embodiments, the stable peroxygen composition may include an alkali metal salt of one or more of: peroxide, percarbonate, persulfate, or perborate. The stable peroxygen composition may consist of, or may consist essentially of, the alkali metal salt of one or more of: peroxide, percarbonate, persulfate, or perborate. For example, the stable peroxygen composition may include sodium percarbonate. The stable peroxygen composition may consist of, or may consist essentially of, the sodium percarbonate.

In various embodiments, the stable peroxygen composition may be present in an amount effective to provide peroxide in a molar ratio to hydroxide from the inorganic base composition. The molar ratio may between about 0.5:1 to about 1.5:1, between about 0.55:1 to about 1.4:1, between about 0.6:1 to about 1.3:1, between about 0.65:1 to about 1.2:1, between about 0.7:1 to about 1.1:1, between about 0.7:1 to about 1:1, between about 0.7:1 to about 0.9:1, between about 0.7:1 to about 0.8:1, about 0.75:1, or a range between about any two of the preceding values, or about any of the preceding values. The stable peroxygen composition may be present in an amount effective to provide a peroxide concentration. The peroxide concentration may have a value in millimoles per liter (mM) of from about 9.55 mM to about 478 mM. In several embodiments, the peroxide concentration in millimoles per liter (mM) may be calculated from the hydroxide concentration based on the above molar ratios of peroxide to hydroxide.

In several embodiments, the stable peroxygen composition may include, e.g., sodium percarbonate, in a weight percentage (w/w) with respect to the water of one or more of about: 0.01% to 3%, 0.01% to 2.5%, 0.01% to 2%, 0.01% to 2%, 0.01% to 1.5%, 0.05% to 1%, 0.1% to 1%, 0.1% to 0.75%, 0.1% to 5%, 0.15% to 0.3%, 0.2% to 0.3%, e.g., about 0.24% or about 0.1% sodium percarbonate. The stable peroxygen composition may consist of, or may consist essentially of, sodium percarbonate in a weight percentage (w/w) with respect to the water of from about 0.01% to about 0.5%.

In various embodiments, the surfactant composition may include two or more alkyl polyglycosides. The surfactant composition may consist of, or may consist essentially of, the two or more alkyl polyglycosides. The surfactant composition may include at least one alkyl polyglucoside. The surfactant composition may consist of, or may consist essentially of, the at least one alkyl polyglucoside. The surfactant composition may include one or more alkyl polyglycosides. The surfactant composition may consist of, or may consist essentially of, the one or more alkyl polyglycosides. Each alkyl in the one or more alkyl polyglycosides may be independently selected from C₆-C₁₈ alkyl. Each alkyl in the one or more alkyl polyglycosides may be independently derived from a fatty alcohol derivative of coconut oil or palm kernel oil. Each alkyl in the one or more alkyl polyglycosides may be independently selected from C₈-C₁₆ alkyl. The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

In various embodiments, the surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%. Suitable alkyl polyglycoside compositions may include, for example, compositions sold under the tradename GLUCOPON®, e.g., GLUCOPON® 420UP, GLUCOPON® 425N, and the like. (BASF Corporation, Florham Park, N.J.). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C₈) glucoside and myristyl (C₁₄) glucoside.

In some embodiments, the surfactant composition may include at least one alkoxylated alcohol, e.g., a propoxylated alcohol, an ethoxylated alcohol, an ethoxylated/propoxylated alcohol, or a combination thereof. For example, the surfactant composition may include an alkoxylated alcohol derived from a C₆-C₁₆ alcohol, a C₁₀-C₁₂ alcohol, a C₁₁-C₁₄ alcohol, a C₁₀-C₁₆ alcohol, a C₉-C₁₁ alcohol, a combination thereof, and the like. One or more of the C₆-C₁₆ alcohol, C₁₀-C₁₂ alcohol, C₁₁-C₁₄ alcohol, C₁₀-C₁₆ alcohol, and C₉-C₁₁ alcohol may include one or more of: a primary alcohol, a secondary alcohol, a tertiary alcohol, a linear alkyl alcohol, and a branched alkyl alcohol. One or more of the alkoxylated C₆-C₁₆ alcohol, C₁₀-C₁₂ alcohol, C₁₁-C₁₄ alcohol, C₁₀-C₁₆ alcohol, and C₉-C₁₁ alcohol may include a free hydroxyl group, i.e., one or more of the C₆-C₁₆ alcohol, C₁₀-C₁₂ alcohol, C₁₁-C₁₄ alcohol, C₁₀-C₁₆ alcohol, and C₉-C₁₁ precursor included more than one hydroxyl group.

Suitable alkoxylated alcohols may include, for example, LPS-T91™ (LPS Laboratories, a division of Illinois Tool Works, Inc., Tucker, Ga.); ETHYLAN™ 1005 SA, ETHYLAN™ 1206, ETHYLAN™ TD-60, ETHYLAN™ 324, ETHYLAN™ 954, ETHYLAN™ 1008 SA, ETHYLAN™ 992, ETHYLAN™ 995, ETHYLAN™ NS 500 K, ETHYLAN™ NS 500 LQ, ETHYLAN™ SN-120, ETHYLAN™ SN-90, ETHYLAN™ TD-1407, and the like (AzkoNobel Surface Chemistry LLC, Chicago, Ill.); TERGITOL™ 15-S-9, TERGITOL™ 15-S-3, TERGITOL™ 15-S-5, TERGITOL™ 15-S-7, TERGITOL™ 15-S-12, TERGITOL™ 15-S-15, TERGITOL™ 15-S-20, TERGITOL™ 15-S-30, TERGITOL™ 15-S-40, and the like (Dow Chemical Company, Midland, Mich.); TOMADOL® 1200, TOMADOL® 91-8, TOMADOL® 1-9, TOMADOL® 1-3, TOMADOL® 1-5, TOMADOL® 1-7, TOMADOL® 1-73B, TOMADOL® 23-1, TOMADOL® 23-3, TOMADOL® 23-6.5, TOMADOL® 25-12, TOMADOL® 25-3, TOMADOL® 25-7, TOMADOL® 25-9, TOMADOL® 45-13, TOMADOL® 45-7, TOMADOL® 600, TOMADOL® 900, TOMADOL® 901, TOMADOL® 902, TOMADOL® 910, TOMADOL® 91-2.5, and TOMADOL® 91-6, and the like (Air Products and Chemicals, Inc. Allentown, Pa.).

The surfactant composition may include at least one alkoxylated alcohol present in a weight percentage (w/w) with respect to the water in the single-phase aqueous solution of one or more of about: 0.025% to 1%; 0.05% to 0.75%; 0.05% to 0.5%; 0.1% to 0.25%; 0.1% to 0.2%; and 0.15%. The surfactant composition may include at least one alkoxylated alcohol present in a weight percentage (w/w) with respect to the water in the single-phase aqueous solution of greater than 1%. The surfactant composition may include at least one alkoxylated alcohol present in a weight percentage (w/w) with respect to the water in the single-phase aqueous solution of up to 5%.

In some embodiments, the surfactant composition may include at least one alkyl polyglycoside and at least one alkoxylated alcohol. The at least one alkyl polyglycoside and the at least one alkoxylated alcohol may include any of the alkyl polyglycosides and any of the alkoxylated alcohols described herein. The at least one alkyl polyglycoside and the at least one alkoxylated alcohol may be present in a weight percentage (w/w) with respect to the water in the single-phase aqueous solution in any of the values and value ranges described herein.

In some embodiments, the single-phase aqueous solution may further include a monosaccharide salt. The single-phase aqueous solution may include a salt of an oxidized monosaccharide. For example, the single-phase aqueous solution may include a salt of glucose, galactose, mannose, fructose, ribose, arabinose, and the like. For example, the single-phase aqueous solution may include a salt of oxidized glucose (i.e., gluconic acid), galactose, mannose, fructose, ribose, arabinose, and the like. As used herein, a salt may include a cationic species and an anionic species. For example, an anionic species may include one or more of: a carboxylate and an alkoxide. The cation may include, for example, an alkali metal, an alkaline earth metal, a transition metal, a protonated amine, and the like. For example, the cation may include Li⁺, Na⁺, K⁺, Cs⁺, Ca²⁺, Mg²⁺, Fe²⁺, Zn²⁺, quinine, and the like.

The monosaccharide salt may be present in the single-phase aqueous solution in a weight percentage (w/w) with respect to the water of one or more of: 0.01, 0.02, 0.05, 0.10, 0.20, 0.30, 0.40, 0.50, 0.60, 0.70, 0.80, 0.90, 1.0, 1.2, 1.4, 1.6, 1.8, 2.0, 2.4, 2.6, 3.0, 3.3, 3.6, 4.0, 4.2, 4.5, 4.7, and 5.0. The monosaccharide salt may be present in the single-phase aqueous solution in a weight percentage (w/w) between any of the preceding values, for example, between about 0.5 and about 1.0, or between about 0.70 and about 2.4, and the like.

In various embodiments, the single-phase aqueous solution may be characterized by a pH value of about one or more of: 10 to 14; 10.5 to 14; 11 to 14; 11.5 to 14; 12 to 14; or 12.5 to 13.5.

In various embodiments a process mixture is provided. The process mixture may include a polymeric substrate, e.g., a polymeric film. The polymeric substrate may include one or more coatings. The process mixture may include a single-phase aqueous solution. The single-phase aqueous solution may include water. The single-phase aqueous solution may include an inorganic base composition. The single-phase aqueous solution may include one or more of: a stable peroxygen composition and a monosaccharide salt. The single-phase aqueous solution may include a surfactant composition. The process mixture may consist essentially of, or may consist of, the polymeric substrate and the single-phase aqueous solution.

In some embodiments, the one or more coatings may include, for example, one or more of: a paint, an ink, a dye, a powder coat, a paper label, a plastic label, an adhesive, a barrier coating, a metalized coating or a bio-coating. The bio-coating may be, for example, protein-based, oligosaccharide-based, and the like.

In several embodiments, the polymeric substrate may be in pieces or particulates, for example, cut, shredded, or ground, e.g., as part of a recycling process. The polymeric substrate, may be in pieces or particles and may be one or more of: recycled; virgin plastic; flexible; fibrous; mixtures thereof; and the like. The polymeric substrate may include one or more of: polyethylene (PE), low-density polyethylene (HDPE), high-density polyethylene (HDPE), polypropylene (PP), biaxially oriented polypropylene (BOPP), polycarbonate (PC), polyethyelene terephthalate (PET), polyethyelene terephthalate-glycerol modified (PET-G), polylactic acid (PLA), polystyrene (PS), copolymers and block copolymers thereof, and the like. The polymeric substrate may include a food packaging film. The polymeric substrate may include a metalized polymer, such as polycarbonate from CD or DVD waste. The polymeric substrate may include a single layered or multilayered film. The polymeric substrate may include a plastic film or container material.

In various embodiments, the single-phase aqueous solution may include any of the features or values for the single-phase aqueous solution as described herein. For example, the single-phase aqueous solution may include the water in a weight percentage (w/w) with respect to the water of at least about one or more of: 95%, 96%, 97%, 98%, 99%, 99.1%, 99.2%, 99.25%, 99.3%, or 99.35%, for example, at least about 95% by weight of water. The single-phase aqueous solution may consist of, or may consist essentially of: at least about 95% by weight of the water; the inorganic base composition; the stable peroxygen composition and/or the monosaccharide salt; and the surfactant composition.

In various embodiments of the process mixture, the inorganic base composition may include one or more of: an alkali metal hydroxide, an alkaline earth metal oxide, or an alkaline earth metal hydroxide. Further, the inorganic base composition may consist of, or may consist essentially of, one or more of: the alkali metal hydroxide, the alkaline earth metal oxide, or the alkaline earth metal hydroxide. As used herein, alkali metals may include, for example, lithium, sodium, potassium, rubidium, or cesium. Alkaline earth metals may include, for example, beryllium, magnesium, calcium, strontium, or barium. For example, the inorganic base composition may include one or more of: lithium hydroxide, sodium hydroxide, potassium hydroxide, magnesium oxide, calcium oxide, magnesium hydroxide, or calcium hydroxide. The inorganic base composition may consist of, or may consist essentially of, one or more of: lithium hydroxide, sodium hydroxide, potassium hydroxide, magnesium oxide, calcium oxide, magnesium hydroxide, or calcium hydroxide. The inorganic base composition may include sodium hydroxide. The inorganic base composition may consist of, or may consist essentially of, sodium hydroxide.

In some embodiments of the process mixture, the inorganic base composition may be present in an amount effective to establish a desired hydroxide concentration in the single-phase aqueous solution. For example, the desired hydroxide concentration may have a molarity in moles/L (M) of: from about 0.0125 to about 0.625, from about 0.025 to about 0.5, from about 0.025 to about 0.375, from about 0.025 to about 0.25, from about 0.025 to about 0.125, about 0.125, about 0.0625, or a value or range of values based on any of the preceding, for example, from about 0.0125 to about 0.625, from about 0.025 to about 0.25, or about 0.125. For example, for sodium hydroxide, a molarity from about 0.025 to about 0.25 may correspond to a in a weight percentage (w/w) with respect to the water of from about 0.1% to about 1%, e.g., about 0.5% sodium hydroxide.

In several embodiments of the process mixture, the stable peroxygen composition may include an alkali metal salt of one or more of: peroxide, percarbonate, persulfate, or perborate. The stable peroxygen composition may consist of, or may consist essentially of, the alkali metal salt of one or more of: peroxide, percarbonate, persulfate, or perborate. For example, the stable peroxygen composition may include sodium percarbonate. The stable peroxygen composition may consist of, or may consist essentially of, the sodium percarbonate.

In various embodiments of the process mixture, the stable peroxygen composition may be present in the single-phase aqueous solution in an amount effective to provide peroxide in a molar ratio to hydroxide from the inorganic base composition. The molar ratio may between about 0.5:1 to about 1.5:1, between about 0.55:1 to about 1.4:1, between about 0.6:1 to about 1.3:1, between about 0.65:1 to about 1.2:1, between about 0.7:1 to about 1.1:1, between about 0.7:1 to about 1:1, between about 0.7:1 to about 0.9:1, between about 0.7:1 to about 0.8:1, about 0.75:1, or a range between about any two of the preceding values, or about any of the preceding values. The stable peroxygen composition may be present in an amount effective to provide a peroxide concentration. The peroxide concentration may have a value in millimoles per liter (mM) of from about 9.55 mM to about 478 mM. In several embodiments, the peroxide concentration in millimoles per liter (mM) may be calculated from the hydroxide concentration based on the above molar ratios of peroxide to hydroxide.

In several embodiments of the process mixture, the stable peroxygen composition may include, e.g., sodium percarbonate, in a weight percentage (w/w) with respect to the water of one or more of about: 0.01% to 3%, 0.01% to 2.5%, 0.01% to 2%, 0.01% to 2%, 0.01% to 1.5%, 0.05% to 1%, 0.1% to 1%, 0.1% to 0.75%, 0.1% to 5%, 0.15% to 0.3%, 0.2% to 0.3%, e.g., about 0.24% or about 0.1% sodium percarbonate. The stable peroxygen composition may consist of, or may consist essentially of, sodium percarbonate in a weight percentage (w/w) with respect to the water of from about 0.01% to about 0.5%.

In various embodiments of the process mixture, the surfactant composition may include two or more alkyl polyglycosides. The surfactant composition may consist of, or may consist essentially of, the two or more alkyl polyglycosides. The surfactant composition may include at least one alkyl polyglucoside. The surfactant composition may consist of, or may consist essentially of, the at least one alkyl polyglucoside. The surfactant composition may include one or more alkyl polyglycosides. The surfactant composition may consist of, or may consist essentially of, the one or more alkyl polyglycosides. Each alkyl in the one or more alkyl polyglycosides may be independently selected from C₆-C₁₈ alkyl. Each alkyl in the one or more alkyl polyglycosides may be independently derived from a fatty alcohol derivative of coconut oil or palm kernel oil. Each alkyl in the one or more alkyl polyglycosides may be independently selected from C₈-C₁₆ alkyl.

The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

In various embodiments of the process mixture, the surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%.

In some embodiments, the surfactant composition may include at least one alkoxylated alcohol, e.g., a propoxylated alcohol, an ethoxylated alcohol, an ethoxylated/propoxylated alcohol, or a combination thereof. For example, the surfactant composition may include an alkoxylated alcohol derived from a C₆-C₁₆ alcohol, a C₁₀-C₁₂ alcohol, a C₁₁-C₁₄ alcohol, a C₁₀-C₁₆ alcohol, a C₉-C₁₁ alcohol, a combination thereof, and the like. One or more of the C₆-C₁₆ alcohol, C₁₀-C₁₂ alcohol, C₁₁-C₁₄ alcohol, C₁₀-C₁₆ alcohol, and C₉-C₁₁ alcohol may include one or more of: a primary alcohol, a secondary alcohol, a tertiary alcohol, a linear alkyl alcohol, and a branched alkyl alcohol. One or more of the alkoxylated C₆-C₁₆ alcohol, C₁₀-C₁₂ alcohol, C₁₁-C₁₄ alcohol, C₁₀-C₁₆ alcohol, and C₉-C₁₁ alcohol may include a free hydroxyl group, i.e., one or more of the C₆-C₁₆ alcohol, C₁₀-C₁₂ alcohol, C₁₁-C₁₄ alcohol, C₁₀-C₁₆ alcohol, and C₉-C₁₁ precursor included more than one hydroxyl group.

The surfactant composition may include at least one alkoxylated alcohol present in a weight percentage (w/w) with respect to the water in the single-phase aqueous solution of one or more of about: 0.025% to 1%; 0.05% to 0.75%; 0.05% to 0.5%; 0.1% to 0.25%; 0.1% to 0.2%; and 0.15%. The surfactant composition may include at least one alkoxylated alcohol present in a weight percentage (w/w) with respect to the water in the single-phase aqueous solution of greater than 1%. The surfactant composition may include at least one alkoxylated alcohol present in a weight percentage (w/w) with respect to the water in the single-phase aqueous solution of up to 5%.

In some embodiments, the surfactant composition may include at least one alkyl polyglycoside and at least one alkoxylated alcohol. The at least one alkyl polyglycoside and the at least one alkoxylated alcohol may include any of the alkyl polyglycosides and any of the alkoxylated alcohols described herein. The at least one alkyl polyglycoside and the at least one alkoxylated alcohol may be present in a weight percentage (w/w) with respect to the water in the single-phase aqueous solution in any of the values and value ranges described herein.

In some embodiments, the single-phase aqueous solution may further include a monosaccharide salt. The single-phase aqueous solution may include a salt of an oxidized monosaccharide. For example, the single-phase aqueous solution may include a salt of glucose, galactose, mannose, fructose, ribose, arabinose, and the like. For example, the single-phase aqueous solution may include a salt of oxidized glucose (i.e., gluconic acid), galactose, mannose, fructose, ribose, arabinose, and the like. As used herein, a salt may include a cationic species and an anionic species. For example, an anionic species may include one or more of: a carboxylate and an alkoxide. The cation may include, for example, an alkali metal, an alkaline earth metal, a transition metal, a protonated amine, and the like. For example, the cation may include Li⁺, Na⁺, K⁺, Cs⁺, Ca²⁺, Mg²⁺, Fe²⁺, Zn²⁺, quinine, and the like.

The monosaccharide salt may be present in the single-phase aqueous solution in a weight percentage (w/w) with respect to the water of one or more of: 0.01, 0.02, 0.05, 0.10, 0.20, 0.30, 0.40, 0.50, 0.60, 0.70, 0.80, 0.90, 1.0, 1.2, 1.4, 1.6, 1.8, 2.0, 2.4, 2.6, 3.0, 3.3, 3.6, 4.0, 4.2, 4.5, 4.7, and 5.0. The monosaccharide salt may be present in the single-phase aqueous solution in a weight percentage (w/w) between any of the preceding values, for example, between about 0.5 and about 1.0, or between about 0.70 and about 2.4, and the like.

In various embodiments, the process mixture and/or the single-phase aqueous solution therein may be characterized by a pH value of about one or more of: 10 to 14; 10.5 to 14; 11 to 14; 11.5 to 14; 12 to 14; or 12.5 to 13.5.

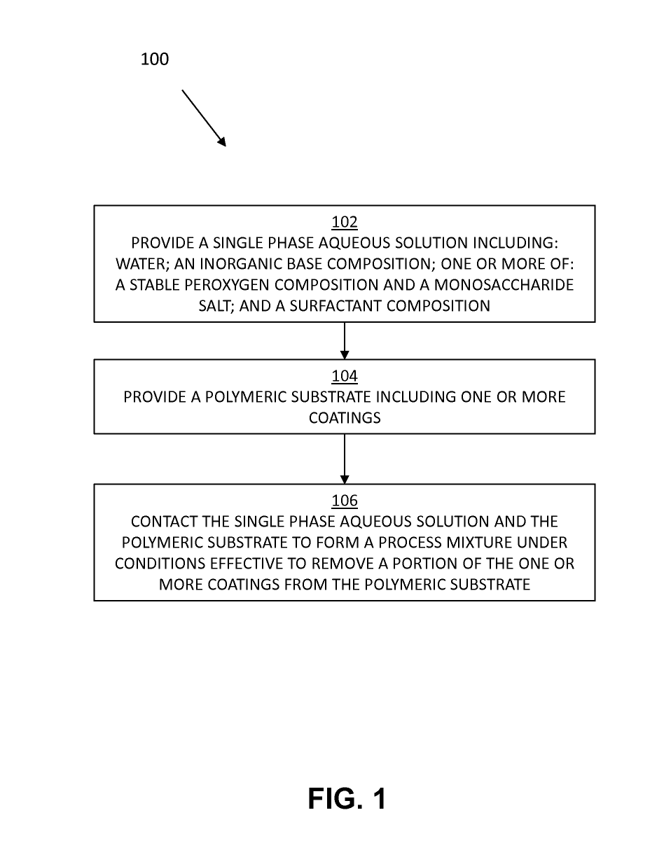

In various embodiments, a method 100 is provided for removing one or more coatings from a polymeric substrate using a single-phase aqueous solution. FIG. 1 depicts a flow chart of method 100. The method may include 102 providing a single-phase aqueous solution. The single-phase aqueous solution may include water. The single-phase aqueous solution may include an inorganic base composition, for example, the inorganic base composition described herein. The single-phase aqueous solution may include one or more of: a stable peroxygen composition and a monosaccharide salt, for example, the stable peroxygen composition and the monosaccharide salt described herein. The single-phase aqueous solution may include a surfactant composition. The method may include 104 providing a polymeric substrate, e.g., a polymeric film, the polymeric substrate including one or more coatings. The method may include 106 contacting the single-phase aqueous solution and the polymeric substrate to form a process mixture under conditions effective to remove a portion of the one or more coatings from the polymeric substrate.

In various embodiments, the conditions effective to remove a portion of the one or more coatings from the polymeric substrate may include heating the process mixture. The process mixture may be heated may be heated at a temperature of about one or more of: between about 60° C. and about 100° C.; 65° C. and about 100° C.; between about 70° C. and about 100° C.; between about 75° C. and about 95° C.; between about 80° C. and about 90° C.; between about 80° C. and about 85° C.; about 85° C.; about 82° C.; or between about any two of the preceding values, or about any of the preceding values, for example, between about 60° C. and about 100° C. or about 85° C.

In various embodiments, the conditions effective to remove a portion of the one or more coatings from the polymeric substrate may include: determining an initial coating amount; heating and agitating the process mixture; determining a process coating amount that is less than about a percentage of the initial coating amount; and recovering the polymeric substrate upon determining the process coating amount is less than about the percentage of the initial coating amount, the percentage of the initial coating amount being one or more of about: 20%, 15%, 14%, 13%, 12%, 11%, 10%, 9%, 8%, 7%, 6%, 5%, 4%, 3%, 2%, and 1%.

In various embodiments, the conditions effective to remove a portion of the one or more coatings from the polymeric substrate may include agitating the process mixture.

In various embodiments, the method may further include recovering the polymeric substrate after removal of the portion of the one or more coatings. The method may further include recovering at least a portion of the single-phase aqueous solution after removal of the portion of the one or more coatings.

In various embodiments, the conditions effective to remove a portion of the one or more coatings from the polymeric substrate may include batch operation. The conditions effective to remove a portion of the one or more coatings may include continuous operation.

In various embodiments, the method may also include using and/or forming the single-phase aqueous solution by stepwise addition to the water of: the inorganic base composition; the surfactant composition; and the stable peroxygen composition and/or the monosaccharide salt.

In some embodiments, the method may further include providing a single-phase aqueous solution including the inorganic base composition, the stable peroxygen composition, and one or more of: a monosaccharide salt and a surfactant composition including an alkoxylated alcohol in addition to an alkyl polyglycoside. In some embodiments, the method may further require monitoring of the process mixture for removal of the one or more coatings. The method may require determining when sufficient removal of the coating is complete, e.g. visual inspection, sample extraction, FTIR analysis of a sample extracted from the process mixture, and the like. The method may require terminating the contact between the single-phase aqueous solution and the polymeric substrate in order to prevent staining of the polymeric substrate.

The method may include providing the single-phase aqueous solution according to any of the features or values for the single-phase aqueous solution as described herein. The method may include preparing the single-phase aqueous solution according to any of the features or values for the single-phase aqueous solution as described herein. The method may include providing the process mixture according to any of the features or values for the single-phase aqueous solution as described herein. The method may include preparing the process mixture according to any of the features or values for the single-phase aqueous solution as described herein.

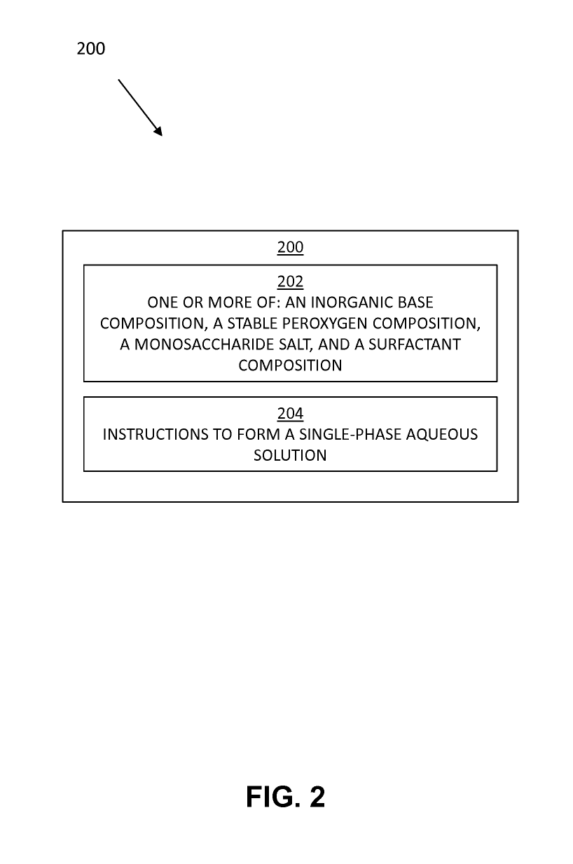

In various embodiments, a kit 200 is provided. FIG. 2 depicts a block diagram of kit 200. Kit 200 may be for making a single-phase aqueous solution for removing one or more coatings from a polymeric substrate. The kit may include 202 one or more of: an inorganic base composition, a stable peroxygen composition, a monosaccharide salt, and a surfactant composition. The kit may include instructions 204. The instructions may direct a user to combine the inorganic base composition, the stable peroxygen composition, the monosaccharide salt, and the surfactant composition with water to form the single-phase aqueous solution.

In some embodiments, the kit may include the inorganic base composition, the stable peroxygen composition and/or the monosaccharide salt, and the surfactant composition. The kit may include at least one of the inorganic base composition, the stable peroxygen composition and/or the monosaccharide salt, and the surfactant composition as a dry composition. The kit may include the inorganic base composition, the stable peroxygen composition and/or the monosaccharide salt, and the surfactant composition together as a single dry mixture. The kit may include the inorganic base composition, the stable peroxygen composition and/or the monosaccharide salt, and the surfactant composition together as an aqueous concentrate. The kit may include the inorganic base composition, the stable peroxygen composition and/or the monosaccharide salt, and the surfactant composition together as the single-phase aqueous solution in ready-to-use format. In several embodiments, the instructions may further direct the user to form a process mixture by contacting the single-phase aqueous solution to the polymeric substrate including the one or more coatings. The instructions may direct the user to provide the single-phase aqueous solution according to any of the features or values for the single-phase aqueous solution as described herein. The instructions may direct the user to prepare the single-phase aqueous solution according to any of the features or values for the single-phase aqueous solution as described herein. The instructions may direct the user to provide the process mixture according to any of the features or values for the single-phase aqueous solution as described herein. The instructions may direct the user to prepare the process mixture according to any of the features or values for the single-phase aqueous solution as described herein.

The instructions may direct the user to provide the single-phase aqueous solution according to any of the features or values for the single-phase aqueous solution as described herein. The instructions may direct the user to prepare the single-phase aqueous solution according to any of the features or values for the single-phase aqueous solution as described herein. The instructions may direct the user to provide the process mixture according to any of the features or values for the single-phase aqueous solution as described herein. The instructions may direct the user to prepare the process mixture according to any of the features or values for the single-phase aqueous solution as described herein.

### EXAMPLES

### Example 1

Approximately 907.19 g of water was added to a mixing tank and heated to about 82° C. While the water was being brought to 82° C., and stirred at approximately 750 RPM, 0.75% (w/w) of 50% (w/v) solution of NaOH, 0.15% (w/w) GLUCOPON® 420UP surfactant (BASF Corporation, Florham Park, N.J.), and 0.10% (w/w) sodium percarbonate, were discretely added, in order to the mixing tank. Approximately 56.70 g of ground food packaging film, approximately 2.54 cm mesh size, was added to the mixing tank and the mixture was stirred at approximately 1000 RPM. After approximately 30 min, the stirring was increased to 1500 RPM to provide consistent and thorough mixing. After 1 h, the mixture was poured over a filter to remove the aqueous phase. The product obtained was judged sufficiently clean with no appearance of remaining ink.

### Example 2

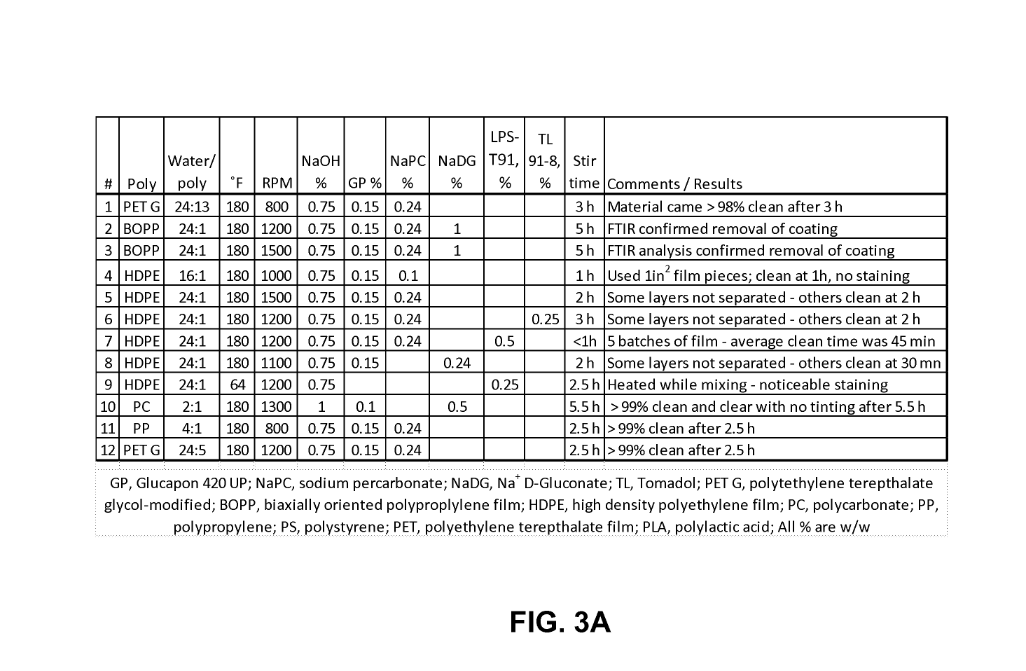

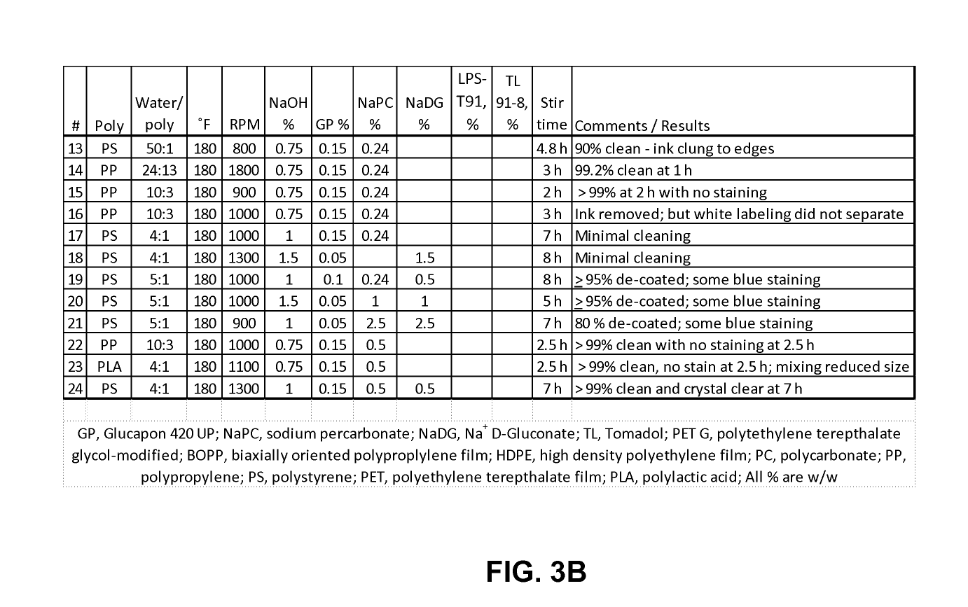

Approximately 4.54 kg of water was added to a mixing tank and heated to about 82° C. While the water was being brought to 82° C., and stirred at approximately 900 RPM, 0.75% (w/w) of 50% (w/v) solution of NaOH, 0.15% (w/w) GLUCOPON® 420UP surfactant (BASF Corporation, Florham Park, N.J.), and 0.24% (w/w) sodium percarbonate were added to the mixing tank. Approximately 1.36 kg of high-flow polypropylene bucket material was added to the mixing tank. After 2 h, the product was judged >99% clean with no appearance of remaining ink. The details of various compositions, reaction parameters, and results of various trials on polypropylene substrates conducted using this same general procedure are shown in FIGS. 3A and 3B, for example, entries 11, 14-16, and 22. Comparable results were found for high density polyethylene, polycarbonate, and poly lactic acid substrates using this same general procedure with the indicated parameters in entries 4-10 and 23.

### Example 3

Approximately 5.44 kg of water was added to a mixing tank and heated to about 82° C. While the water was being brought to 82° C., and stirred at approximately 1200 RPM, 0.75% (w/w) of 50% (w/v) solution of NaOH, 0.15% (w/w) GLUCOPON® 420UP surfactant (BASF Corporation, Florham Park, N.J.), and 0.24% (w/w) sodium percarbonate were added to the mixing tank. Approximately 1.13 kg of polyethylene terephthalate container material was added to the mixing tank. After 2.5 h, the product was judged >99% clean with no appearance of remaining ink. The details of various compositions, reaction parameters, and results of various trials on polyethylene terephthalate substrates conducted using this same general procedure are shown in FIGS. 3A and 3B, for example, entries 1 and 12.

### Example 4

Approximately 4.54 kg of water was added to a mixing tank and heated to about 82° C. While the water was being brought to 82° C., and stirred at approximately 800 RPM, 0.75% (w/w) of 50% (w/v) solution of NaOH, 0.15% (w/w) GLUCOPON® 420UP surfactant (BASF Corporation, Florham Park, N.J.), and 0.24% (w/w) sodium percarbonate were added to the mixing tank. Approximately 90.72 g of polystyrene foam cup material was added to the mixing tank. After 4.5 h, the product was judged >90% clean. The details of various compositions, reaction parameters, and results of various trials on polystyrene substrates conducted using this same general procedure are shown in FIGS. 3A and 3B, for example, entries 13, 17-21, and 24.

### Example 5

Approximately 5.44 kg of water was added to a mixing tank and heated to about 82° C. While the water was being brought to 82° C., and stirred at approximately 1000 RPM, 0.75% (w/w) of 50% (w/v) solution of NaOH, 0.15% (w/w) GLUCOPON® 420UP surfactant (BASF Corporation, Florham Park, N.J.), 0.24% (w/w) sodium percarbonate, and 1.0% (w/w) sodium D-gluconate were added to the mixing tank and the mixture was stirred at approximately 1500 RPM. Approximately 226.80 g of biaxially-oriented polypropylene film was added to the mixing tank. After 5 h, the product was determined clean by FTIR. The details of various compositions, reaction parameters, and results of various trials on biaxially-oriented polypropylene substrates using this same general procedure are shown in FIGS. 3A and 3B, for example, entries 2 and 3.

### Example 6

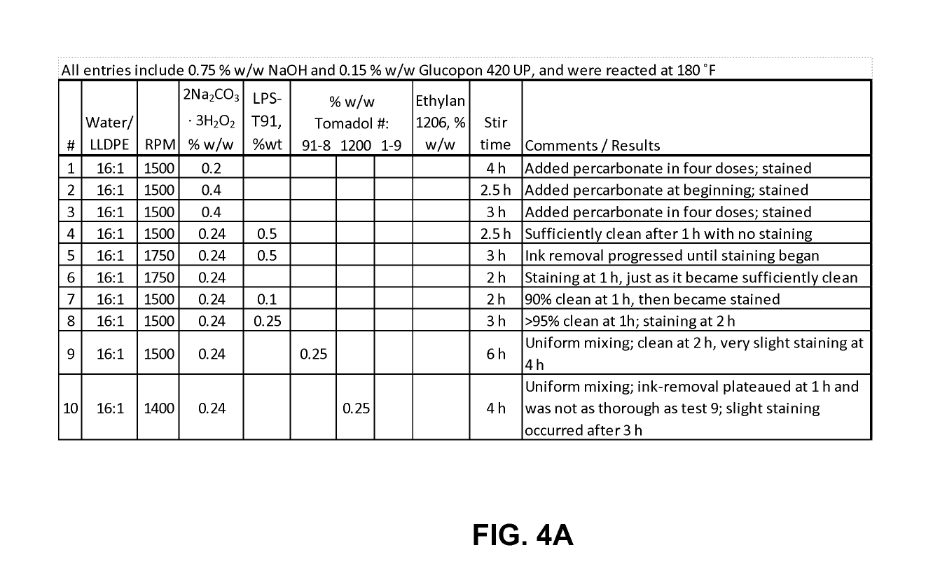

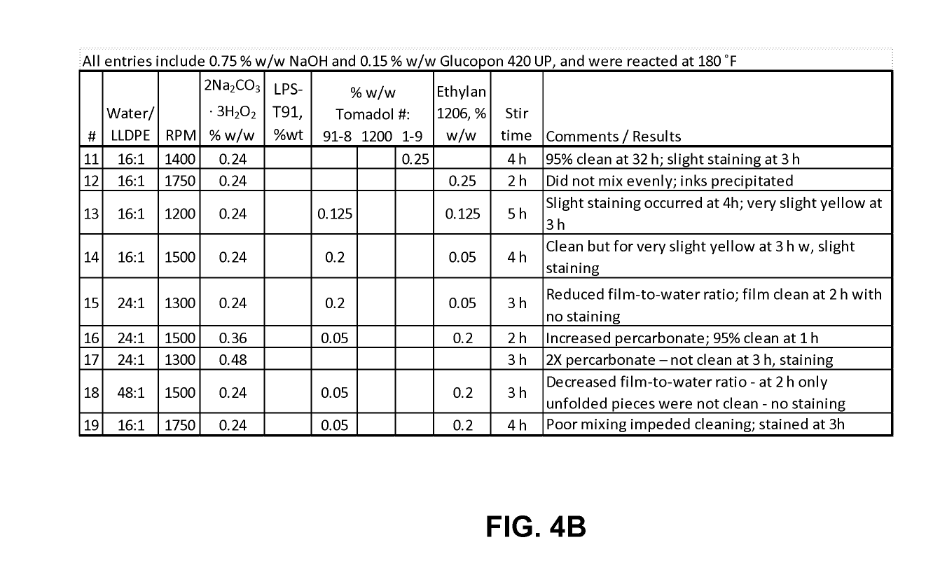

Approximately 5.44 kg of water was added to a mixing tank and heated to about 82° C. While the water was being brought to 82° C., and stirred at approximately 800 RPM, 0.75% (w/w) of 50% (w/v) solution of NaOH, 0.15% (w/w) GLUCOPON® 420UP surfactant (BASF Corporation, Florham Park, N.J.), 0.24% (w/w) sodium percarbonate, and 0.25% (w/w) LPS-T91™ (LPS Laboratories, a division of Illinois Tool Works, Inc., Tucker, Ga.) were added to the mixing tank and the mixture was stirred at approximately 1500 RPM. Approximately 340.19 g of ground linear low density polyethylene (LLDPE) film from a personal care product (diapers) was added to the mixing tank. After 1 h, the product was judged >95% clean. After 2 h, staining of the film occurred. The details of various compositions, reaction parameters, and results of various trials on linear low density polyethylene film using this same general procedure are shown in FIGS. 4A and 4B.

### Example 7

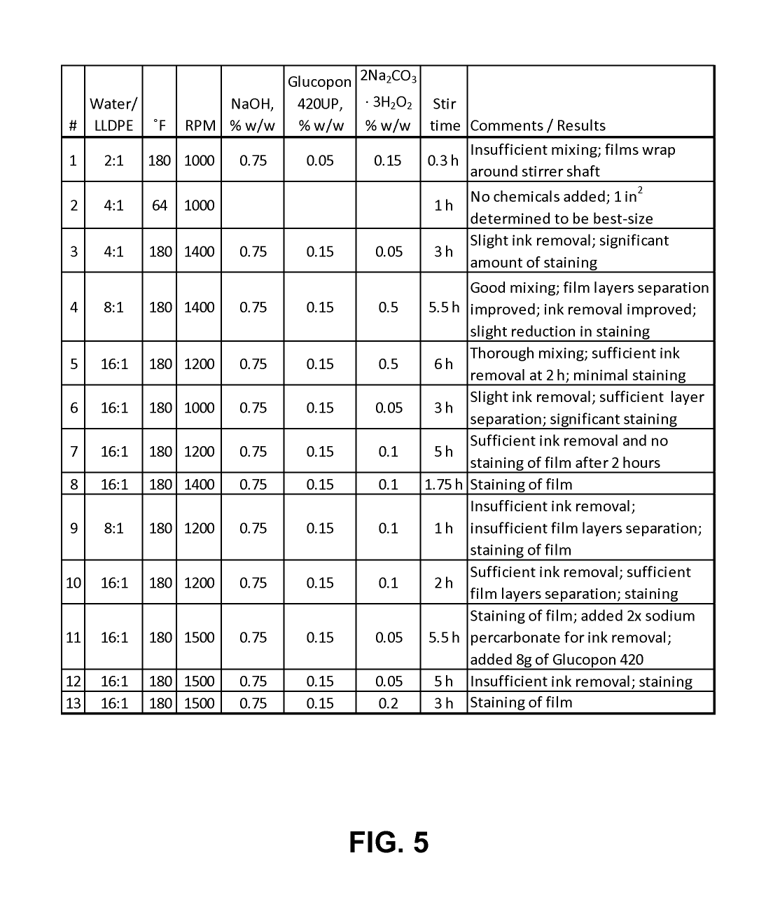

Approximately 5.44 kg of water was added to a mixing tank and heated to about 82° C. While the water was being brought to 82° C., and stirred at approximately 750 RPM, 0.75% (w/w) of 50% (w/v) solution of NaOH, 0.15% (w/w) Glucopon 420UP® surfactant (BASF Corporation, Florham Park, N.J.), and 0.20% (w/w) sodium percarbonate, were discretely added, in order, to the mixing tank. Approximately 340.2 g of ground diaper film, approximately 2.54 cm mesh size, was added to the mixing tank and the mixture was stirred at approximately 1000 RPM. After approximately 30 min, the stirring was increased to 1500 RPM to provide consistent and thorough mixing and prevent layer separation. After 3 h, the mixture was poured over a filter to remove the aqueous phase. The product obtained appeared stained due to ink re-deposition. The details of various compositions, reaction parameters, and results of various trials on linear low density polyethylene film using this same general procedure are shown in FIG. 5.

### Example 8

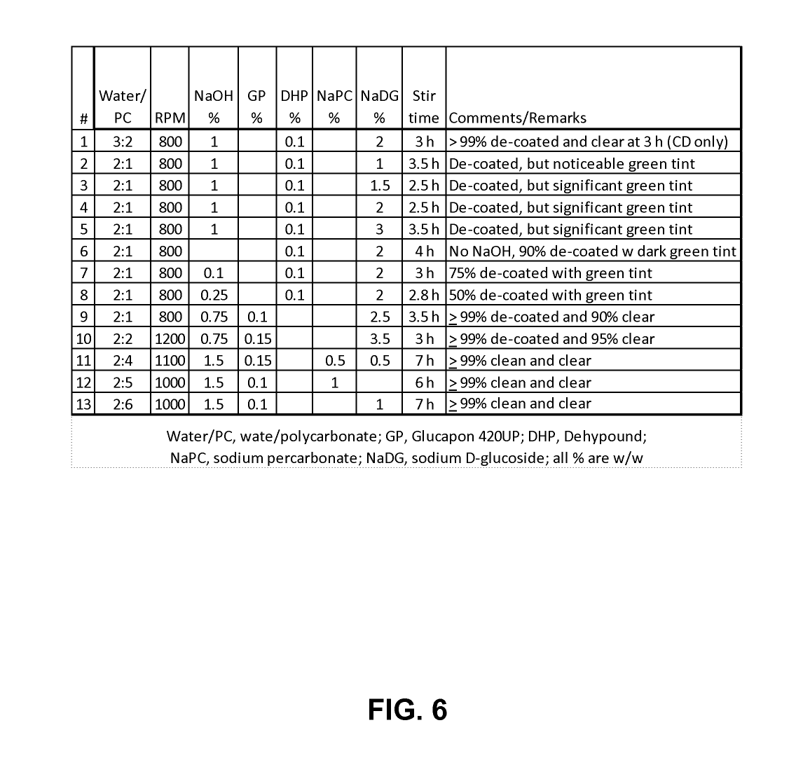

FIG. 6 is a table of compositions, reaction parameters, and results of several trials for EXAMPLE 8 conducted generally according to the procedure of EXAMPLE 2 on metalized polycarbonate, e.g., from CD and DVD waste. Excellent results were obtained, particularly with combinations of NaOH, GLUCOPON® 420UP surfactant (BASF Corporation, Florham Park, N.J.), and one or both of sodium percarbonate and sodium D-gluconate, particularly for entries 1 and 9-13 in FIG. 6.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles (i.e., CN). A “per”-substituted compound or group is a compound or group having all or substantially all substitutable positions substituted with the indicated substituent. For example, 1,6-diiodo perfluoro hexane indicates a compound of formula C₆F₁₂I₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (i.e., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tert-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The various aspects and embodiments disclosed herein are for purposes of illustration and are not intended to be limiting, with the true scope and spirit being indicated by the following claims.

1. A single-phase aqueous solution for removing one or more coatings from a polymeric substrate, comprising:
water;
an inorganic base composition;
one or more of a stable peroxygen composition and a monosaccharide salt; and
a surfactant composition.

2. The single-phase aqueous solution of claim 1, the inorganic base composition being present in an amount effective to establish a hydroxide concentration in moles/liter (M) of about one or more of: 0.0125 M to 0.625 M; 0.025 M to 0.5 M; 0.025 M to 0.375 M; 0.025 M to 0.25 M; 0.025 M to 0.125 M; and 0.0625 M.

3. The single-phase aqueous solution of claim 1, the inorganic base composition comprising sodium hydroxide in a weight percent concentration (w/w) with respect to the water of about 0.375%.

4. The single-phase aqueous solution of claim 1, the stable peroxygen composition comprising sodium percarbonate.

5. The single-phase aqueous solution of claim 1, the stable peroxygen composition being present in an amount effective to provide a peroxide concentration having a molarity of from about 9.55 mM to about 478 mM.

6. The single-phase aqueous solution of claim 1, the surfactant composition comprising one or more alkyl polyglycosides, each alkyl in the one or more alkyl polyglycosides being independently derived from one or more of: a fatty alcohol derivative of coconut oil or palm kernel oil; and a C₈-C₁₆ alkyl.

7. The single-phase aqueous solution of claim 1, the surfactant composition comprising at least one alkyl polyglycoside and at least one alkoxylated alcohol.

8. The single-phase aqueous solution of claim 1, further comprising the monosaccharide salt including sodium D-gluconate.

9. The single-phase aqueous solution of claim 1, the surfactant composition being present in a weight percentage (w/w) with respect to the water of one or more of about: 0.01% to 0.5%; 0.025% to about 0.4%; 0.05% to 0.3%; 0.075% to 0.25%; 0.1% to about 0.2%; and 0.15%.

10. A method 100 for removing one or more coatings from a polymeric substrate using a single-phase aqueous solution, comprising:
102 providing a single-phase aqueous solution comprising: water; an inorganic base composition; one or more of a stable peroxygen composition and a monosaccharide salt; and a surfactant composition;
104 providing a polymeric substrate, the polymeric substrate comprising one or more coatings; and
106 contacting the single-phase aqueous solution and the polymeric substrate to form a process mixture under conditions effective to remove a portion of the one or more coatings from the polymeric substrate.

11. The method of claim 9, the conditions effective to remove a portion of the one or more coatings from the polymeric substrate comprising heating the process mixture at a temperature of about 60° C. to 100° C.

12. The method of claim 9, the conditions effective to remove a portion of the one or more coatings from the polymeric film comprising: determining an initial coating amount; heating and agitating the process mixture; determining a process coating amount that is less than about a percentage of the initial coating amount; and recovering the polymeric film upon determining the process coating amount is less than about the percentage of the initial coating amount, the percentage of the initial coating amount being one or more of about: 20%, 15%, 14%, 13%, 12%, 11%, 10%, 9%, 8%, 7%, 6%, 5%, 4%, 3%, 2%, or 1%.

13. The method of claim 9, comprising providing the water in a weight ratio to the polymeric substrate of one or more of about: 4:1 to 32:1; 8:1 to 24:1; 10:1 to 20:1; 12:1 to 18:1; 14:1 to 18:1; 15:1 to 17:1; and 16:1.

14. The method of claim 9, the inorganic base composition comprising sodium hydroxide.

15. The method of claim 9, the stable peroxygen composition comprising sodium percarbonate.

16. The method of claim 9, the surfactant composition comprising one or more alkyl polyglycosides, each alkyl in the one or more alkyl polyglycosides being independently derived from one or more of: a fatty alcohol derivative of coconut oil or palm kernel oil; and a C₈-C₁₆ alkyl.

17. The method of claim 9, the surfactant composition comprising at least one alkyl polyglycoside and at least one alkoxylated alcohol.

18. The method of claim 9, further comprising monitoring the process mixture for removal of the one or more coatings; and recovering the polymeric substrate from being in contact with one or more of: the single-phase aqueous solution, the inorganic base composition, the peroxygen composition, the monosaccharide salt, and the surfactant composition before staining of the polymeric substrate occurs.

19. The method of claim 9, the polymeric substrate comprising one or more of: polyethylene (PE), low-density polyethylene (HDPE), high-density polyethylene (HDPE), polypropylene (PP), biaxially oriented polypropylene (BOPP), polycarbonate (PC), polyethyelene terephthalate (PET), polyethyelene terephthalate-glycerol modified (PET-G), polylactic acid (PLA), and polystyrene (PS).

20. A kit for making a single-phase aqueous solution for removing one or more coatings from a polymeric substrate, comprising:
an inorganic base composition, a stable peroxygen composition, a monosaccharide salt, and a surfactant composition; and
instructions, the instructions directing a user to combine the inorganic base composition, the stable peroxygen composition, the monosaccharide salt, and the surfactant composition with water to form the single-phase aqueous solution.

21. The kit of claim 19, the instructions further directing the user to remove the one or more coatings from the polymeric film comprising the one or more coatings by at least one of: heating the process mixture, agitating the process mixture, recovering the polymeric substrate after removal of a portion of the one or more coatings, or recovering at least a portion of the single-phase aqueous solution.
